(19) United States
(12) Patent Application Publication
(10) Pub. No.: US 2008/0029579 A1
(43) Pub. Date: Feb. 7, 2008

(54) Heating device

(75) Inventors: Jens Gammelin, Wald-Michelbach (DE); Peter Gammelin, Wald-Michelbach (DE); Joerg Nolte, Marktheidenfeld (DE)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: REWATRONIK GMBH

(21) Appl. No.: 11/785,990

(22) Filed: Apr. 23, 2007

(30) Foreign Application Priority Data
Jun. 9, 2006 (DE) 102006026948.9

(51) Int. Cl. H05B 1/00; B23K 35/14

(52) U.S. Cl. 228/56.3; 219/229

(57) ABSTRACT

The invention relates to a heating device for heating an electrical or electronic component, with the heating device comprising a blower for conveying a gas stream and a heating apparatus through which the gas stream can be guided and heated. The heating device further comprises a heating storage apparatus which is capable of at least partly storing and emitting the heat of the gas stream guided through and heated by the heating apparatus. It also comprises an infrared radiator, with the heat emitted by the heating apparatus and the heating storage apparatus and the heat from the infrared radiator being provided for heating the electronic component. It is thus possible to achieve higher temperatures at the solder contacts of the component than in an individually used infrared radiator or hot-air radiator.

### CROSS-REFERENCE TO RELATED APPLICATIONS

This application claims priority to German Patent Application No. DE 102006026948.9, filed Jun. 9, 2006, the disclosure of which is hereby incorporated by reference in its entirety.

### FIELD OF THE TECHNOLOGY

The invention relates to a heating device for heating an electrical or electronic component and a soldering system with such a heating device.

### BACKGROUND OF THE INVENTION

The electric connection of electrical and electronic components can occur by metallurgical methods such as soldering for example. In the case of surface-mounted components (SMDs) on printed circuit boards, hot-air/hot-gas soldering methods or radiation soldering methods are used. These methods are widely used and have proven their worth. As a result of stricter environmental regulations however, there is a necessity to make improvements to the soldering method. The legislator has recently imposed different requirements concerning the production of electrical and electronic appliances. In the “Directive 2002/95/EC of the European Parliament and of the Council of 27 Jan. 2003 on the restriction of the use of certain hazardous substances in electrical and electronic equipment”, which is also known as the RoHS Directive (Restriction of certain Hazardous Substances), the member states are asked to ensure that electrical and electronic equipment brought onto the market from 1 Jul. 2006 must no longer contain any lead among other things (Article 4(1) of the Directive). This also relates to the soldering paste used in production. In comparison with lead-containing soldering pastes, the processing of lead-free pasts requires higher soldering temperatures in so-called reflow soldering. The temperature range when using lead-free soldering pastes changes from approximately 210° C. to 235° C. for lead-containing soldering pastes to approximately 230° C. to 260° C. for lead-free soldering pastes. Such a temperature must be achieved on the soldering surface or soldering points of the components to be mounted in order to achieve a favorable soldering joint. This applies both to components which have their soldered connections only on their outside wall lateral to the housing (“quad flat package” or QFP) or only on their bottom side or beneath the housing (“ball grid array” or BGA).

The higher soldering temperature can principally be achieved by an increase in the output of the employed heat sources. It needs to be ensured that the radiation surface of the heat sources is not enlarged, because the dimensions of the components to be soldered have not changed. This means when using a hot-air soldering method that a higher blower output is required. Small components to be mounted can easily be displaced from their intended soldering position in the case of higher blower outputs, thus leading to placement errors. Moreover, a hot-air soldering method requires expensive special nozzles when the soldering surfaces at the outside edge of a component to be soldered are to be arranged and reached in a purposeful manner. Furthermore, the heat-soaking of components such as a BGA where the soldering points are arranged on the bottom side is not as effective when using a hot-air soldering method as a radiation soldering method.

A frequently used radiation soldering method is the infrared radiation soldering method. In comparison with the hot-air soldering method it comes with the advantage that a lower energy input is required in order to reach a required temperature. If a higher heat quantity is emitted in the infrared radiation soldering method, the radiation spectrum of the emitted infrared waves moves to the long-wave range over 10 μm. The absorption behavior of the dark components to be mounted change as a result, so that an increase in the heat quantity is subject to narrow limits when using the infrared radiation soldering method. In the case of components with a large mass, infrared radiation generally leads to a relatively slow heating, whereas small components can be overheated relatively quickly.

### SUMMARY OF THE INVENTION

It is therefore the object of the present invention to provide a heating device and a soldering system with which electrical and electronic components of different sizes and with soldered connections at the edge or the bottom can be heated quickly and reliably to soldering temperatures of up to 260° C. evenly over their entire component surface, with the heat-emitting surface of the heating device in accordance with the invention remaining unchanged in comparison with previous heating devices and with the required additional need for energy increasing only slightly.

This object is achieved by the features of the independent claims. Advantageous embodiments of the invention are shown in the sub-claims.

The heating device in accordance with the invention for heating an electrical or electronic component comprises a blower for conveying a gas stream and a heating apparatus through which the gas stream can be guided and heated. It further comprises a heating storage apparatus which is capable of at least partly storing and emitting the heat of the gas stream guided through and heated by the heating apparatus. It further comprises an infrared radiator, with the heat emitted by the heating apparatus and the heating storage apparatus and the heat from the infrared radiator being provided for heating the electronic component. Therefore, both a blower with an associated heating apparatus as well as an infrared radiator are used in the heating device in accordance with the invention. Such a “hybrid heating device” combines the advantages of both principles: The infrared radiator only needs to be operated strongly enough that its radiation spectrum is situated in a wavelength range which is optimal for heating electronic components, so that a shifting in the direction to long-wave radiation does not occur. In order to achieve higher temperatures, the additional heat can be contributed by means of a blower and an additional heating apparatus. Excess heat is stored by using a heating storage apparatus, so that overheating of a component to be heated and soldered is prevented. The high required soldering temperatures therefore do not need to be achieved in the heating device in accordance with the invention only by the blower with a heating apparatus alone, so that the blower can be provided with a relatively low power input. It causes an only relatively low air pressure, so that there is only a very low likelihood for placement errors for the components to be soldered. The major part of the heating energy applied can be supplied by the infrared radiator, which already now only requires approximately 25% of the energy as is incurred in a hot-air soldering method.

According to a preferred embodiment, the heating storage apparatus and the infrared radiator are arranged in such a way that the heated gas stream can be guided at least partly past its respective boundary region. This ensures that a heat flow is guided to the boundary region of the heating device and lateral soldered connections of a component are heated, which component is situated under the heating device and is to be heated. It is further possible that the surface of the electronic component is supplied with heat predominantly as radiation heat, whereas soldering points situated at the outer edge are subjected to a concentrated heat flow additionally and in a locally limited manner.

If the heating storage apparatus and/or the infrared radiator comprise nozzles through which the gas stream can be guided, a direct flow and a higher flow speed can be achieved at the nozzle end.

One end of the heating device facing the electronic component can be arranged in accordance with another embodiment in such a way that a gas stream emerging from the heating device is emitted in a focused manner. A gas stream which is guided past the boundary region of the heating device can be concentrated towards the electronic component.

The heating device is preferably formed as a heating pipe in which the blower, the heating apparatus, the heating storage apparatus and the infrared radiator are arranged one behind the other. A compact heating pipe is thus realized which can be arranged as a hand-held device.

It is advantageous when the heating apparatus and the infrared radiator are coupled with a controlling apparatus in such a way that a heat quantity emitted by the heating device can be controlled. This ensures achieving optimal heat supply depending on the size and the type of housing of a component to be soldered. The temperature difference between component housing and soldering surface can thus be reduced considerably. This is achieved especially well when the heating apparatus and the infrared radiator can be controlled independent from each other by the controlling apparatus. When the controlling apparatus is coupled with a temperature sensor such as a resistance temperature sensor, a cheap, maintenance-free and precise temperature measurement can be carried out. Such a resistance temperature sensor usually has a linear characteristic, so that temperature control is easy to realize. When an infrared sensor is used, a contactless temperature measurement can be carried out which supplies very precise results when the emission factor is known and with an optical system for focusing a measuring spot.

According to a further embodiment, the heating storage apparatus can be heated by the gas stream and infrared radiation emitted by an infrared radiator. This enables efficient utilization of energy and excess heat does not lead to any likelihood that the housing of the electronic component is overheated.

Preferably, the gas stream comprises air and/or a noble gas. Air is the least expensive and most easily available energy carrier, whereas a noble gas allows an improved soldered joint and wetting and higher wetting speed as a result of the exclusion of oxygen. Noble gas also allows simpler soldering with lead-free soldering pastes.

This object is further achieved by a soldering system with a heating device as described above.

### BRIEF DESCRIPTION OF THE DRAWINGS

The invention is now described below in closer detail by reference to embodiments shown in the drawings, wherein:

FIG. 1 shows a schematic view of an embodiment of a heating device in accordance with the invention;

FIG. 2 shows a schematic view of a heating device in accordance with the invention with a coupled controlling apparatus;

FIG. 3 shows a temperature-time diagram for a component to be soldered when a heating device is used in which only an infrared radiator is used, and

FIG. 4 shows a temperature-time diagram for a component to be soldered when a heating device in accordance with the invention is used in which an infrared radiator and a blower are used.

### DETAILED DESCRIPTION OF THE INVENTION

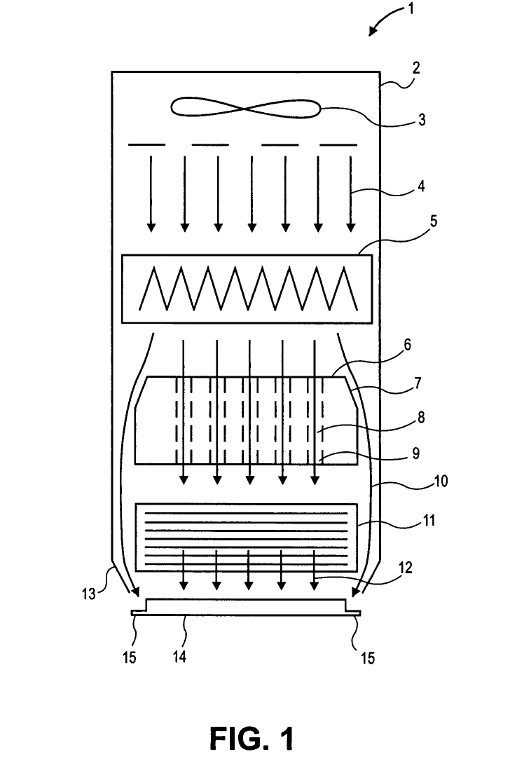

FIG. 1 schematically shows a cross sectional-view of a heating device in accordance with the invention. The heating device 1 comprises a heating pipe 2 which houses all components of the heating device. A blower is provided in the upper region of the heating pipe 2 which supplies room air (and/or a noble gas) to the heating pipe 2 (see arrow 4). The aspirated air reaches a heating apparatus 5 which preheats the air in its interior and emits the same to the outside. The preheated air then reaches to a major part a downstream heating storage apparatus 6 which is provided with channels 8 through which the air is pressed. It emits heat to the heating storage apparatus 6. The channels can be provided with nozzles 9 at the end at which the air exits, so that the air exits with a higher speed than at the entrance into the heating storage apparatus. The air then reaches a downstream infrared radiator 11 which emits heat radiation itself and additionally guides the supplied heated air through fine nozzles in the direction of a component 14 to be heated. A heat radiation therefore acts upon the component housing which is represented by arrows 12.

A part of the air heated by the heating apparatus 5 does not reach the heating storage apparatus, but is guided to the outer edge of the heating storage apparatus 6, for example supported by a sloping area 7 on the heating storage apparatus 6 (see flow arrow 10). It flows from there past the outer edge of the infrared radiator 11 in the direction towards the component 14. Said lateral heating flow 10 is only delimited by the housing of the heating pipe 2 and reaches a pipe end 13 which is folded in such a way that the air flow 10 is focused towards the component 14. This ensures that soldering surfaces 15 of the component 14 which are situated on the outside are irradiated in a purposeful manner with a relatively high amount of heating energy, so that high temperatures can be reached on the soldering surfaces 15 for solder-free pastes.

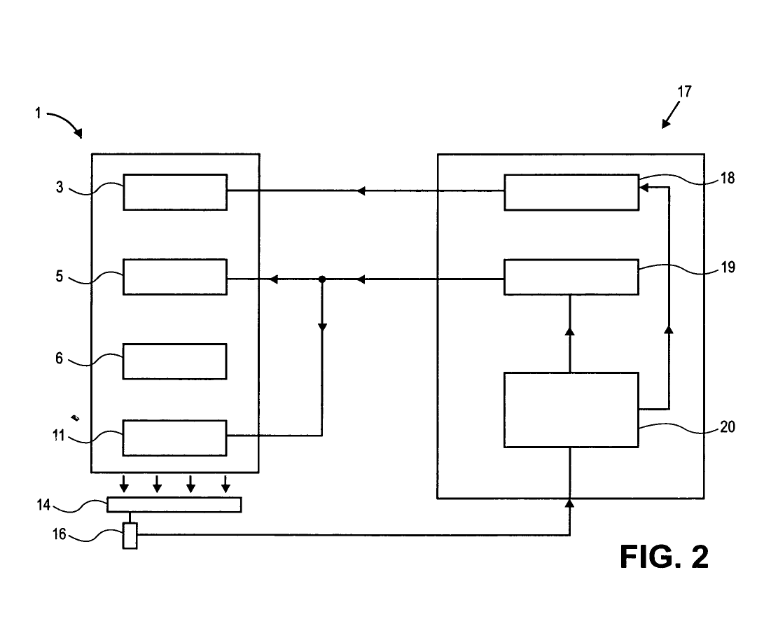

The efficient emission of heat can be achieved by using a controlling apparatus 17 depending on the component to be heated (see FIG. 2). As already explained above, the heating device 1 comprises a blower 3, a heating apparatus 5, a heating storage apparatus 6 and an infrared radiator 11. In order to regulate the emission of heat on a component 14 arranged beneath the heating device, the same is coupled with at least one temperature sensor 16. It can concern a resistance temperature sensor or an infrared sensor for example. The signal of the temperature sensor is supplied to the controlling apparatus 17 and there to a microprocessor 20 which is connected with a variable power unit 19 for preselecting the temperature of the heating apparatus 5 and the infrared radiator 11 which is coupled with the same. The microprocessor 20 is further connected with a variable power supply 18 or a speed controller for the blower 3 which is coupled with the same.

In the case of soldered connections 15 of component 14 which are situated on the outside, the blower 3 or the heating apparatus 5 assumes a large part of the heat generation, such that the heat flow 10 is guided along the inner boundary region of the heating pipe 2. The infrared radiator 11 is triggered in such a way however that it emits only a relatively low amount of heat. As a result, the middle portion of the component housing 14 meets only very few shares of the infrared radiator and additionally some shares of the hot air which were guided through the heating storage apparatus 6 and the infrared radiator 11. Such a heat emission ensures that the soldered connections 15 can be heated to high temperatures, while the housing of component 14 is only heated to such an extent that no undesirable heat tensions occur as a result of an excessive temperature difference between the soldered connections and the middle portion of the component.

The regulation of the blower 3, the heating apparatus 5 and the infrared radiator 6 can be carried out differently in components whose soldered connections are arranged on the bottom side. In that case it is not necessary that a lateral air flow 10 supplies a high amount of heat energy to a boundary region of the component. As a result, the infrared radiator 11 and the heating apparatus 5 are predetermined with a higher temperature by the controlling device 17 or the power unit 19, whereas the blower 3 is triggered in such a way that it causes an only very low air flow. An even supply of heat to the entire surface of component 14 is thus possible, with the outside regions of the component no longer being heated additionally.

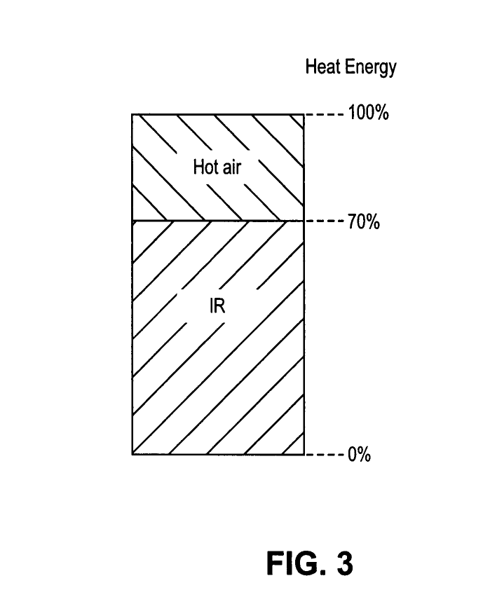

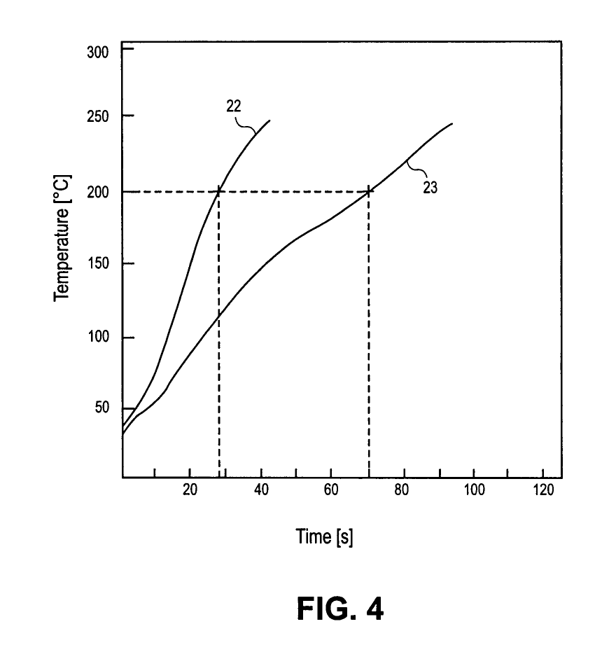

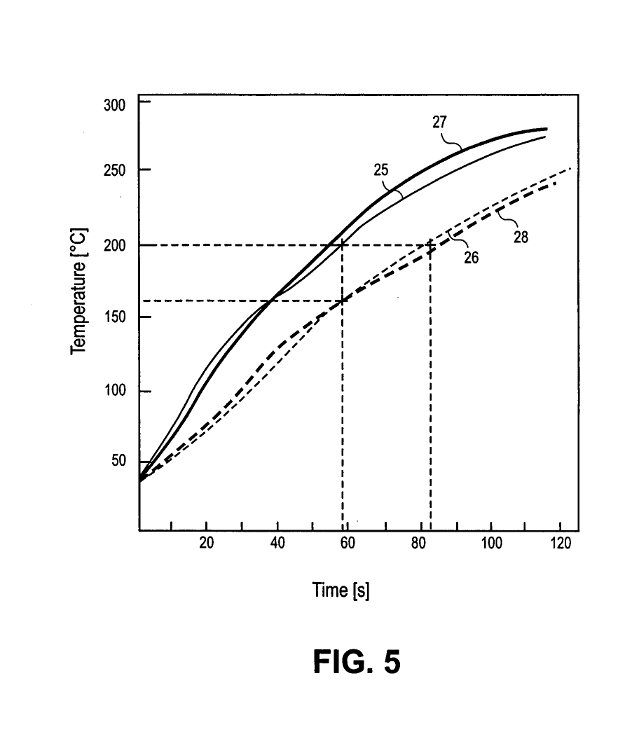

FIGS. 3 and 4 show temperature-time diagrams. They show the measured temperature rise depending on the time for different situations. Temperature curves are shown for a component housing and the associated solder contacts. FIG. 3 shows the situation that a blower was not activated, so that only infrared radiation was available for heating. The housing heated up relatively quickly (see curve with reference numeral 22), so that a temperature of 200° C. was reached after approximately 28 seconds. At this time the solder contacts only showed a temperature of approximately 110° C. (see curve with reference numeral 23), so that there was a temperature difference of 90 K. The 200° C. of the housing were reached by the solder contacts only after 71 seconds, corresponding to a time difference of 43 seconds. If the infrared radiator is supported by a blower and a heating apparatus, as is the case in the heating apparatus in accordance with the invention, significantly different temperature curves are obtained (see FIG. 4). It shows two pairs of curves. This first pair of curves 25, 26 shows the situation in a blower which was operated with an operating voltage of 6 VDC. The second pair of curves 27, 28 shows the situation in a blower which was operated with an operating voltage of 9 VDC. The housing (see reference numeral 25) reached a temperature of 200° C. after approximately 57 seconds. The solder contacts (see reference numeral 26) had a temperature of 200° C. approximately 26 seconds later, so that the same temperature was reached in a 40% shorter time than in the case described in FIG. 3. The solder contacts already had a temperature of 160° C. at the time at which the housing had reached a temperature of 200° C., so that in comparison with the case as described in FIG. 3 there was a temperature difference lower than by approximately 50% in the amount of only 40 K. Virtually the same measuring results were obtained at a higher blower voltage of 9 VDC, with curve 27 showing the temperature progress of the housing and curve 28 the temperature progress of the associated solder contacts.

The temperature curves shown in FIG. 4 show that the apparatus in accordance with the invention allows reaching a lower temperature difference between housing and solder contacts than in cases where only an infrared radiator is used. The apparatus allows further achieving temperatures of approx. 250° C. at the solder contacts.

1. A heating device for heating an electrical or electronic component, with the heating device comprising a blower for conveying a gas stream and a heating apparatus through which the gas stream can be guided and heated, comprising:
a heating storage apparatus which is capable of at least partly storing and emitting the heat of the gas stream guided through and heated by the heating apparatus; and
an infrared radiator, which the heat emitted by the heating apparatus and the heating storage apparatus and the heat from the infrared radiator is provided for heating the electronic component.

2. A heating device according to claim 1, wherein the heating storage apparatus and the infrared radiator are arranged in such a way that the heated gas stream can be guided at least partly past their respective boundary region.

3. A heating device according to claim 1, wherein the heating storage apparatus and/or the infrared radiator comprise nozzles through which the gas stream can be guided.

4. A heating device according to claim 1, wherein an end of the heating device facing the electronic component is arranged in such a way that a gas stream emerging from the heating device exits in a focused manner.

5. A heating device according to claim 1, wherein the heating device is shaped as a heating pipe in which the blower, the heating apparatus, the heating storage apparatus and the infrared radiator are each arranged behind one another.

6. A heating device according to claim 1, wherein the heating apparatus and the infrared radiator are coupled with a controlling apparatus in such a way that a heat quantity emitted by the heating device can be regulated.

7. A heating device according to claim 6, wherein the controlling apparatus can be used to regulate the heating apparatus and the infrared radiator independently from each other.

8. A heating device according to claim 6, wherein the controlling apparatus is coupled with a temperature sensor, preferably a resistance temperature sensor or infrared sensor.

9. A heating device according to claim 1, wherein the heating storage apparatus can be heated by the gas stream and infrared radiation emitted by the infrared radiator.

10. A heating device according to claim 1, wherein the gas stream comprises air and/or a noble gas.

11. A soldering system with a heating device according to claim 1.
